(19) United States
(12) Patent Application Publication
(10) Pub. No.: US 2006/0077214 A1
(43) Pub. Date: Apr. 13, 2006

(54) Method and apparatus for adjusting the brightness of a display device

(75) Inventors: Ching-Mei Tsou, Taipei City (TW); Tse-I Chao, Taipei City (TW); Shin-Chieh Yuan, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: TATUNG CO., LTD., Taipei (TW)

(21) Appl. No.: 11/010,390

(22) Filed: Dec. 14, 2004

(30) Foreign Application Priority Data
Oct. 8, 2004 (TW) 093130661

(51) Int. Cl. G09G 5/10

(52) U.S. Cl. 345/690

(57) ABSTRACT

A method and system for adjusting the brightness of a display device. Using a light detection unit detects the current environmental brightness thereby generates a first reference value and a second reference value. a brightness degree is obtained according to a conversion formula by using the first reference value and the second reference value as parameters. A comparison is performed to compare the obtained brightness degree with a first predetermined value and a second predetermined value to determine the brightness degree and the predetermined value. If the brightness is greater than the first reference value, smaller than the second reference value, or between the first reference value and the second reference value, a warning light device will be activated to inform the user. a backlight module automatically adjusts the brightness device according to the brightness degree thereby lets the brightness device correspond to the current environment and the user's requirement.

### BACKGROUND OF THE INVENTION

1. Field of the Invention

The present invention relates to a method and apparatus for adjusting the brightness of a display device, and more particularly, to a method and apparatus adapted in a tablet PC or a laptop in order to inform the user about the environmental brightness by using warning lights, and to automatically adjust the brightness of the display device.

2. Description of Related Art

Generally, the user has to adjust the brightness of a display device by manually controlling the brightness variation through a control panel. As shown in FIG. 1, adjustment keys 6 are coupled to the surface of a display device 5, such as a tablet PC or a laptop, to adjust display parameters for indirectly adjust the displayed brightness.

However, since the tablet PC is portable, the user may usually change the environment wherever he/she wants to use the tablet PC thereby leads to a brightness problem. For example, removing the tablet PC from a living room with a higher brightness to a bedroom with a lower brightness causes an over-lightened brightness of the tablet PC; removing the tablet PC from a bedroom with a lower brightness to a living room with a higher brightness causes an over-darkened brightness of the tablet PC. Consequently, it's very inconvenient for the user to adjust the displayed brightness or even to adjust the environmental brightness all the time in order to keep the brightness in a good manner.

Therefore, it is desirable to provide an improved computing device capable of error notification and its method to mitigate and/or obviate the aforementioned problems.

### SUMMARY OF THE INVENTION

The object of the present invention is to provide a method and apparatus for adjusting the brightness of a display device in order to automatically detect the environmental brightness, display a warning light to inform the user, and automatically adjust the brightness of the display device to provide a comfortable brightness for the user.

To achieve the object, the method for adjusting the brightness of a display device of the present invention comprises the steps of: (A) generating a first reference value by a light detection unit; (B) generating a second reference value by the light detection unit; (C) generating a brightness degree according to the first reference value and the second reference value; (D) displaying a first warning light by a brightness warning device if the brightness degree is greater than a first predetermined value, and then jumping to step (G); (E) displaying a second warning light by the brightness warning device if the brightness degree is smaller than a second predetermined value, and then jumping to step (G), wherein the second predetermined value is smaller than the first predetermined value; (F) displaying a third warning light by the brightness warning device if the brightness degree is between the first predetermined value and the second predetermined value, and then jump to step (H); (G) adjusting the brightness of the display device by a backlight unit according to the intensity of the brightness degree; and (H) ending the execution.

According to another aspect of the present invention, an apparatus for adjusting the brightness of a display device of the present invention comprises a backlight unit for controlling the brightness of a backlight panel of the display device; a light detection unit for detecting a reference value of a current environmental brightness of the display device; an embedded control IC for calculating the reference value detected by the light detection unit to obtain a reference degree, and generating a control signal for controlling the backlight unit; and a brightness warning device comprising at least three warning lights for displaying one of the warning lights according to the control signal from the embedded control IC in order to indicate the current environmental brightness of the display device.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a conventional brightness adjustment device of a display device;

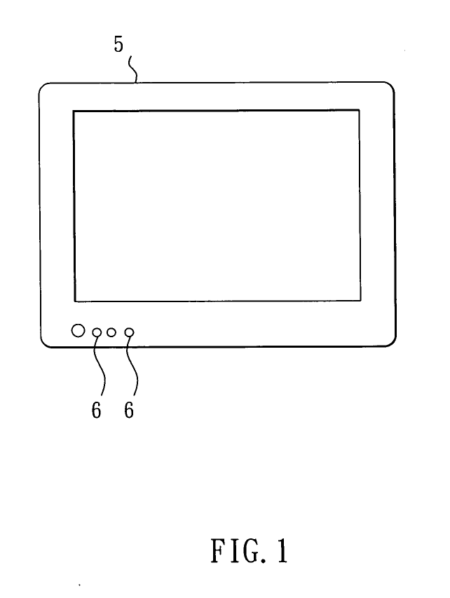

FIG. 2 is a schematic drawing of a display device according to the present invention;

FIG. 3 is a flowchart of adjusting the brightness of a display device according to the present invention;

FIG. 4 is a detailed flowchart of adjusting the brightness of a backlight module according to the present invention; and

FIG. 5 is a block diagram according to the present invention.

### DETAILED DESCRIPTION OF THE PREFERRED EMBODIMENT

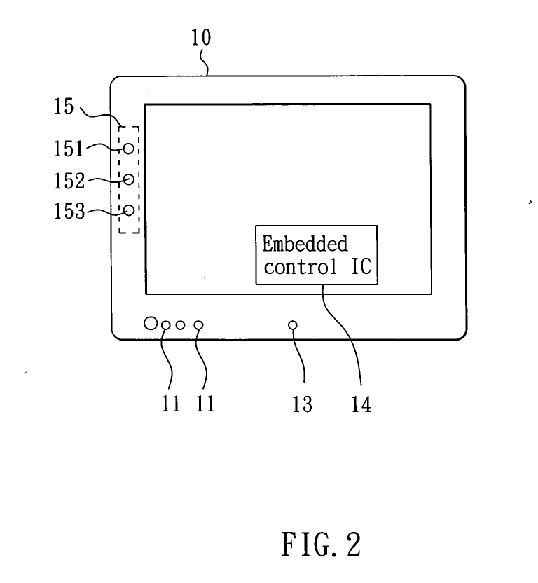

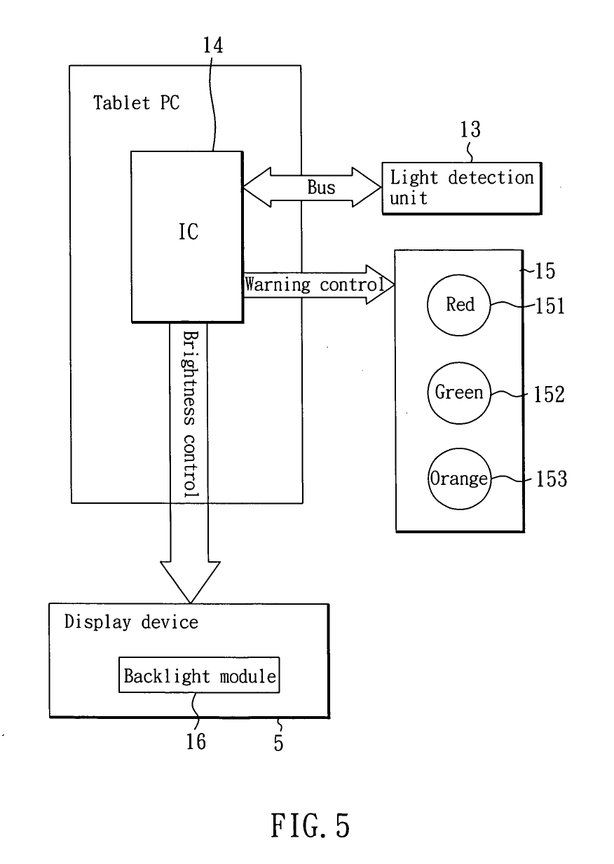

Please refer to FIG. 2 and FIG. 5. In this embodiment, FIG. 2 is a schematic drawing of a tablet PC, and FIG. 5 is a block diagram of a brightness device of the tablet PC. An embedded control IC 14 and a light detection unit 13 are installed inside of the display device 10. The detection unit 13 is adapted for detecting the current environmental brightness of the display device 10, and the embedded control IC 14 is capable of calculating the displayed brightness of the display device 10. Therefore, the display device 10 represents its current brightness by using warning lights 151, 152, 153 of a brightness warning device 15 according to information obtained from the detection unit 13 and the embedded control IC 14. In this embodiment, the brightness warning device 15 has three warning lights: using the red warning light 151 represents the display device 10 is currently under an over-lightened brightness environment; using the green warning light 152 represents the display device 10 is currently under an appropriate brightness environment; using the orange warning light 153 represents the display device 10 is currently under an over-darkened brightness environment. By means of showing different warning lights and using the embedded control IC 14 to control the brightness of the backlight module 16, the user can be informed about the situation of the current environmental brightness without feeling uncomfortable with the over-lightened or over-darkened displayed brightness.

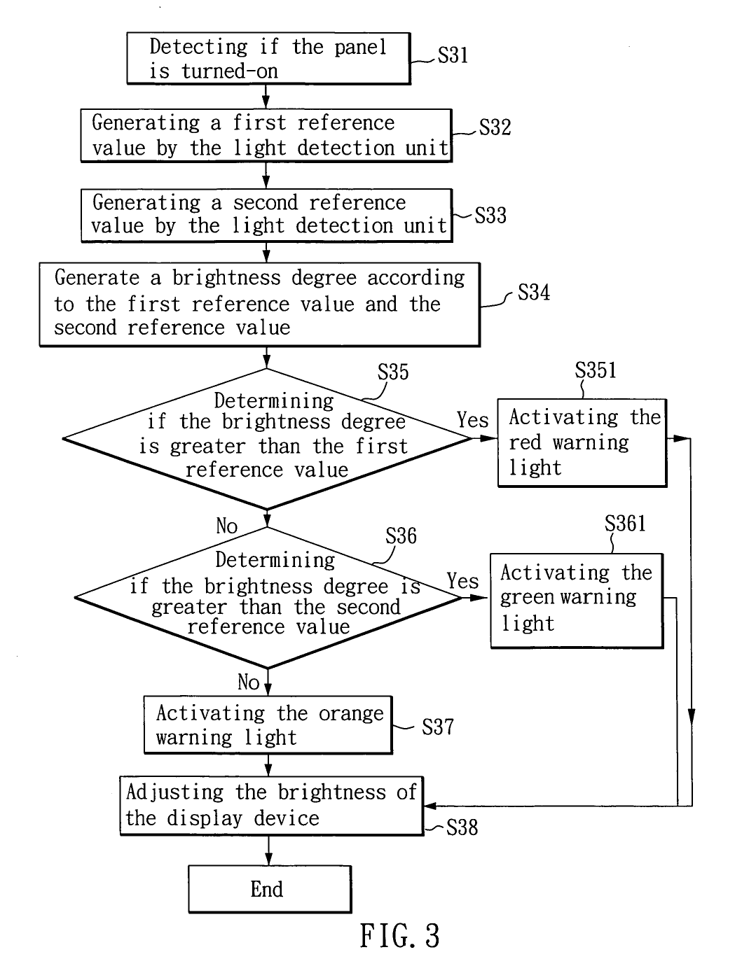

With reference to FIG. 3, there is shown a flowchart of adjusting the brightness of the display device according to the embodiment of the invention. At first, the method detects whether the panel has already been turned-on (S31). If so, the light detection unit 13 generates a first reference value (S32) and a second reference value (S33). In this embodiment, the light detection unit 13 detects the infrared light value of the current environment thereby generates the first reference value; the light detection unit 13 detects the visible light value and the infrared light value of the current environment thereby generates the second reference value.

A brightness degree can be obtained according to a conversion formula by using the first reference value and the second reference value as parameters (S34). The conversion formula is as, but not limited to, the following:
R=(first reference value)/(second reference value) (1)
Brightness value=(second reference value)*0.46*e^{-3.13R} (2)

Next, an analog-to-digital (A/D) conversion is performed to the brightness value for obtaining the brightness degree. The variation range of the brightness degree is preferably between 0 and 255, wherein 0 represents the panel with the darkest brightness degree, while 255 represents the panel with the brightest brightness degree. Obviously, the variation range of the brightness degree can be varied according to user's requirement without limited to the aforesaid range.

After obtaining the brightness degree, the embedded control IC 14 compares the brightness degree with a first predetermined value and a second predetermined value to determine whether the current environmental brightness is appropriate so that the determination can be regarded as a reference for controlling the brightness warning device 15 and the backlight module 16. In the embodiment, the first predetermined value is 750 lux, and the second predetermined value is 300 lux.

The brightness degree greater than 750 lux (i.e. the first predetermined value) represents the environmental brightness is over-lightened (S35). Therefore the embedded control IC 14 activates the red warning light 151 of the brightness warning device 15 so as to inform the user (S351), and controls the backlight module 16 to adjust the brightness of the display device 10 (S38).

The brightness degree between 750 lux (i.e. the first predetermined value) and 300 lux (i.e. the second predetermined value) represents the environmental brightness is appropriate (S36). Then the embedded control IC 14 activates the green warning light 152 of the brightness warning device 15 so as to inform the user (S361).

The brightness degree smaller than 300 lux (i.e. the second predetermined value) represents the environmental brightness is over-darkened. Therefore the embedded control IC 14 activates the orange warning light 153 of the brightness warning device 15 so as to inform the user (S37), and controls the backlight module 16 to adjust the brightness of the display device 10 (S38).

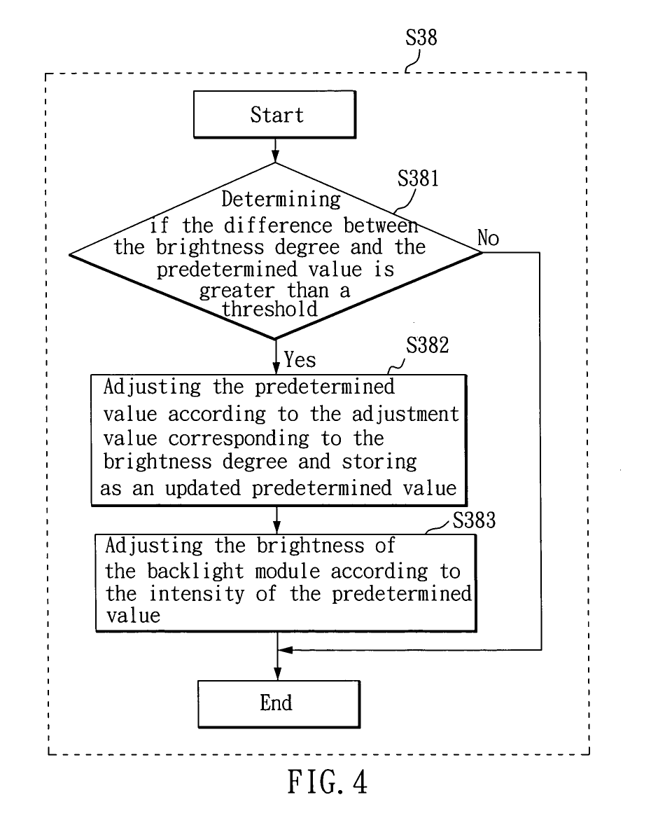

Please refer to FIG. 4. FIG. 4 illustrates a detailed flowchart of S38 in FIG. 3. At first, a comparison is performed between the brightness degree generated in S34 and a predetermined value to calculate a difference between them, wherein the predetermined value is the current brightness value of the display device 10. Then, a comparison is performed to determine whether the difference between the brightness degree and the predetermined value is greater than a threshold (S381). If not, it represents that the brightness variation of the current environment for the display device 10 is minor and under an acceptable range of brightness variation for the user's vision. So the displayed brightness would be reserved without adjusting the brightness value of the display device 10. Otherwise, if the difference is indeed greater than the threshold, it represents that the brightness variation of the current environment for the display device 10 exceeds the acceptable range of brightness variation. Consequently, the predetermined value would be adjusted according to an adjustment value corresponding to the brightness degree and to be stored as an updated predetermined value (S382). Finally, the brightness of the backlight module 16 would be adjusted according to the intensity of the predetermined value (S383).

The above-mentioned adjustment values are related to the value of different brightness degrees. In the embodiment, the variation range between 0 and 255 of the brightness degree is divided, but not limited, into four sections. The variation range between 0 and 60 is classified as a first section with an adjustment value as 1; the variation range between 61 and 125 is classified as a second section with an adjustment value as 2; the variation range between 126 and 216 is classified as a third section with an adjustment value as 3; and the variation range between 217 and 255 is classified as a fourth section with an adjustment value as 4. For example, if the brightness degree is 100 within the second section, its corresponding adjustment value is 2 as an addend or a subtrahend when adjusting the brightness. Based on such a rule, the brightness of the display device 10 can be smoothly adjusted to the most appropriate brightness value for the user's vision. If the brightness degree is greater than the predetermined value, the adjustment value is used as an addend; on the contrary, if the brightness is smaller than the predetermined value, the adjustment value is used as a subtrahend. The threshold is regarded as a criterion for determining whether to activate the backlight module 16 for adjustment or not. The threshold can be 5, 10, or 15. In this embodiment, the threshold is preferably 5. Accordingly, if the brightness degree is 100 and the predetermined value is 104, the backlight module 16 wouldn't be activated to adjust the brightness because the difference between the brightness degree and the predetermined value is 4 smaller than 5. If the brightness is 95 and the predetermined value is 104, the backlight module 16 would be activated to adjust the brightness because the difference between the brightness degree and the predetermined value is 9 greater than 5. That is, the backlight module 16 subtracts 2 from the predetermined value and stores the result as an updated predetermined value which is 102. If the brightness is 110 and the predetermined value is 104, the backlight module 16 would be activated to add 2 to the predetermined value and store the result as an updated predetermined value which is 106 because the difference between the brightness degree and the predetermined value is 8 greater than 5. According to the description mentioned above, the present invention uses the light detection unit 13 to detect the brightness variation of the current environment so as to control the panel brightness and warning lights in order to inform the user, and thereby helps the user to realize the current environmental brightness and the brightness of the display device. Further, the present invention automatically adjusts the brightness of the display device to provide a smoother brightness variation and a more comfortable displayed brightness to the user.

Although the present invention has been explained in relation to its preferred embodiment, it is to be understood that many other possible modifications and variations can be made without departing from the spirit and scope of the invention as hereinafter claimed.

What is claimed is:

1. A method for adjusting the brightness of a display device, comprising the steps of:
(A) generating a first reference value by a light detection unit;
(B) generating a second reference value by the light detection unit;
(C) generating a brightness degree according to the first reference value and the second reference value;
(D) displaying a first warning light by a brightness warning device if the brightness degree is greater than a first predetermined value, and then jumping to step (G);
(E) displaying a second warning light by the brightness warning device if the brightness degree is smaller than a second predetermined value, and then jumping to step (G), wherein the second predetermined value is smaller than the first predetermined value;
(F) displaying a third warning light by the brightness warning device if the brightness degree is between the first predetermined value and the second predetermined value, and then jump to step (H);
(G) adjusting the brightness of the display device by a backlight unit according to the intensity of the brightness degree; and
(H) ending the execution.

2. The method as claimed in claim 1, wherein the display device is selected from a tablet PC, a liquid crystal display (LCD), and a laptop.

3. The method as claimed in claim 1, wherein the light detection unit is coupled to the surface of the display device.

4. The method as claimed in claim 1, wherein the first reference value is selected from an infrared light value.

5. The method as claimed in claim 1, wherein the second reference value is selected from a visible light value and an infrared light value.

6. The method as claimed in claim 1, wherein the brightness degree is a lux value of visible light.

7. The method as claimed in claim 1, wherein the first predetermined value is 750 lux.

8. The method as claimed in claim 1, wherein the second predetermined value is 300 lux.

9. The method as claimed in claim 1, wherein step (G) further comprises the steps of:
(G1) determining if the difference between the brightness degree and a predetermined value is greater than a threshold, adjusting the predetermined value according to an adjustment value corresponding to the brightness degree and storing as an updated predetermined value; and
(G2) adjusting the brightness of the display device according to the intensity of the predetermined value.

10. The method as claimed in claim 9, wherein if the brightness degree is greater than the predetermined value and the difference between the brightness degree and the predetermined value is greater than the threshold, step (G1) adjusts the predetermined value by adding the adjustment value to the predetermined value.

11. The method as claimed in claim 10, wherein a variation range of the brightness degree is divided into at least one section each corresponding to a unique adjustment value.

12. The method as claimed in claim 11, wherein the variation range of the brightness degree is between 0 and 255.

13. The method as claimed in claim 11, wherein the variation range of the brightness degree is divided into four sections each adjustment value respectively corresponding to 1, 2, 3, and 4.

14. The method as claimed in claim 9, wherein if the brightness degree is smaller than the predetermined value and the difference between the brightness degree and the predetermined value is greater than the threshold, step (G1) adjusting the predetermined value by subtracting the adjustment value from the predetermined value.

15. The method as claimed in claim 14, wherein a variation range of the brightness degree is divided into at least one section each corresponding to a unique adjustment value.

16. The method as claimed in claim 15, wherein the variation range of the brightness degree is between 0 and 255.

17. The method as claimed in claim 16, wherein the variation range of the brightness degree is divided into four sections each adjustment value respectively corresponding to 1, 2, 3, and 4.

18. An apparatus for adjusting the brightness of a display device, comprising:
a backlight unit for controlling the brightness of a backlight panel of the display device;
a light detection unit for detecting a reference value of a current environmental brightness of the display device;
an embedded control IC for calculating the reference value detected by the light detection unit to obtain a reference degree, and generating a control signal for controlling the backlight unit; and
a brightness warning device comprising at least three warning lights for displaying one of the warning lights according to the control signal from the embedded control IC in order to indicate the current environmental brightness of the display device.

19. The apparatus as claimed in claim 18, wherein the brightness warning device comprises a first warning light, a second warning light, and a third warning light; the first warning light is displayed if the brightness degree is greater than a first predetermined value; the second warning light is displayed if the brightness degree is smaller than a second predetermined value; the third warning light is displayed if the brightness degree is between the first predetermined value and the second predetermined value.
